(19) United States
(12) Patent Application Publication
(10) Pub. No.: US 2012/0310404 A1
(43) Pub. Date: Dec. 6, 2012

(54) METHOD FOR DETECTING THE STRUCTURE OF A TEXTILE MULTI-FILAMENT PRODUCT AND METHOD FOR PROCESSING A TEXTILE MULTI-FILAMENT PRODUCT

(75) Inventors: Tobias Schmidt, Augsburg (DE); Thomas Putz, Westendorf (DE); Heide Gommel, Augsburg (DE)

(73) Assignee: SGL CARBON SE, WIESBADEN (DE)

(21) Appl. No.: 13/505,004

(22) PCT Filed: Sep. 9, 2010
(86) PCT No.: PCT/EP2010/063228

§ 371 Date: Aug. 21, 2012

(30) Foreign Application Priority Data
Oct. 30, 2009 (DE) 10 2009 051 426.0

(51) Int. Cl. G06F 19/00

(52) U.S. Cl. 700/143

(57) ABSTRACT

A method for detecting the structure of a textile multi-filament product and a method for processing a textile multi-filament product includes detecting the structure. In the method for detecting the structure of the textile multi-filament product, a fed multi-filament product is optically detected in a linear/sectioned manner in a detecting direction different than the feeding direction in order to obtain primary detection data. The detection data are evaluated and a parameter and/or a change thereto describing the structure of the multi-filament product is derived therefrom. The parameter or the change thereto is used in the processing method to control a pre-processing step or a processing step.

### FIELD OF THE INVENTION

The invention relates to a method for detecting the structure of a textile multi-filament product and a method for processing a textile multi-filament product. In particular, the present invention relates to a method and a system for online or real-time measurement/regulation of the band width or generally of the structure of a textile multi-filament product, in particular based on carbon fibers.

### BACKGROUND OF THE INVENTION

Materials based on fibers, in particular carbon fibers or carbon fibers, and textile multi-filament structures are enjoying great popularity as a result of their exceptional material properties. In order to ensure a high quality, the properties of the initial and intermediate products forming the basis for such materials, e.g. the individual textile fibrous materials or the roving yarns or rovings, must be monitored during the manufacture or also during the intermediate uptake. Such monitoring first and foremost assumes that it is possible to be able to detect metrologically, describe and evaluate the structure of the initial and intermediate products.

A random intermediate check—e.g. by visual inspection—is on the one hand generally barely sufficient, personnel intensive and liable to error and on the other hand can scarcely be integrated into an automated process in a convincing manner.

### SUMMARY OF THE INVENTION

It is the object of the invention to provide a method for detecting the structure of a textile multi-filament product and a method for processing a textile multi-filament product in which the structural properties of the multi-filament product can be determined in a particularly simple and nevertheless reliable manner and be used to regulate processing steps.

The object forming the basis of the invention is solved by a method for detecting the structure of a textile multi-filament product according to the invention having the features of the independent patent claim 1. The object forming the basis of the invention is further solved by a method for processing a textile multi-filament product according to the invention having the features of the independent patent claim 10. Advantageous further developments are the subject matter of the respective dependent claims.

The present invention provides on the one hand a method for detecting the structure or a structural feature of a textile multi-filament product. In this case, there are provided steps S1 of feeding a multi-filament product in a feed direction z, S2 of linear/sectional optical detection of the multi-filament product in a detecting direction y different from the feed direction z and thereby S3 obtaining primary detection data, S4 evaluating the primary detection data and S5 deriving at least one parameter p describing the structure of the multi-filament product and/or a change thereto Δp from the evaluation S4 of the primary detection data.

The following explanations of the terms are given for further understanding:

Textile fibrous materials in the sense of the invention are linear structures which can be processed as textiles (textile fibers). They possess the common characteristic of a large length in relation to their cross-section and sufficient strength and flexibility.

The textile fibrous materials are divided according to their origin or material condition.

Fiber count is understood as the ratio between mass and length of the fibrous material. A distinction is made between coarse, fine, ultrafine and micro-fibers.

Continuous fibers or filaments are fibers of almost unlimited length. Spin fibers are fibers of limited length.

Threads consisting of a plurality of filaments are described as multi-filaments.

Rovings are fiber bundles or fiber strands consisting of endless, untwisted, stretched filaments, e.g. having diameter of 6 μm to 10 μm.

Multi-axial scrims, or also called scrims, are textile surface structures and belong to the 3D textiles. Scrims consist of individual fiber bundles or rovings which are arranged in a plane parallel to one another (unidirectional) and/or in layers of different fiber orientation one above the other—in this case, called multi-axial scrims. The positions of the layers are fixed by a stitch system.

Tailored fiber placement describes the manufacture of textile structures by applying dry fiber rovings by means of a thread by sewing or embroidery onto a sewing base (underlayer).

Fiber splicing is the splitting of a roving having a high number of filaments into a plurality of thin rovings having a lower number of filaments.

Fiber patch placement describes a method for manufacturing fiber slivers which are spread and bound on one side, so-called patches which are cut into small pieces in order to then be deposited in a defined manner.

The multi-filament product can be supplied continuously S1. This is particularly simple if the product is obtained and supplied directly from a manufacturing process or from an intermediate deposit—e.g. from a spool, spindle or roller.

The optical detection S2 can also be carried out continuously or quasi-continuously. In particular, however, the primary data are detected many times or continued to certain time points t0, t1, t2.

The multi-filament product can be detected optically, for example, by means of a video recording, in particular using a video system or video recording system. In principle, any optical means can be used as long as the necessary spatial resolution is ensured.

The evaluation S4 of the primary optical detection data which in this case is formed, for example, by one or more video recordings, is then made on the basis of a corresponding line or line of pixels, image points or image elements which extend in particular along the detecting direction y.

Alternatively to this, the multi-filament product can be detected optically, for example, by means of an optical sweeping or scanning using an optical line scanning device or line scanning device where these comprise a plurality of light detecting elements or optical detecting elements. The evaluation S4 is thereby made using the primary line signals forming the detection data.

The evaluation S4 of the primary optical detection data and/or the derivation S5 of the parameter p describing the structure of the multi-filament product can be accomplished by means of a 1-bit coding with a predefined threshold value IS.

This is in particular possible by means of a contrast or intensity distribution in a video image or in a scanned line in the detecting direction y.

However, other codings are also possible, e.g. when detailed structural information—i.e. beyond a light-dark scheme—is to be derived.

A yarn, a roving yarn, a roving, a twist, a threading, in particular a single- or multiply scrim and/or a woven fabric or any combination of these structures of textile fibrous material can be detected as textile multi-filament product.

On the other hand, however a product comprising or made of carbon fibers, precursor fibers of carbon fibers, ceramic fibers, glass fibers, polymer fibers (e.g. aramid) and/or mixtures or combinations thereof, in particular relative to the total weight of a respective fiber layer can be detected as textile multi-filament product, in particular if it comprises structures having 1K to 48K or even beyond this, structures having more than 48K. In particular structures having more than 50K can also be detected. It is also feasible to detect structures of up to 320K and beyond. The width of the product, in particular in the sense of a band width B, can be derived as the parameter p describing the structure of the multi-filament product.

The presence, the distribution and/or the position of gaps or gaps G′ can be derived as an alternative parameter or features. This is in particular of great advantage in the case of woven fabrics, when several yarns, roving yarns or rovings etc. are used simultaneously, because valuable information can then be obtained about the gap distribution in the structure.

If one or more parameters p describing the structure of the multi-filament product and/or a change thereto Δp is determined, these can also be displayed, stored and/or read out. This results in completely new types of possibilities for analysis and intervention for regulation, for example, in a fabrication process, for example, in the sense of a process documentation.

According to a further aspect of the present invention, by applying the method according to the invention for detecting the structure of a textile multi-filament product, a method for processing a multi-filament product is provided, and specifically comprising a processing step in which a supplied multi-filament product is processed, and comprising a pre-processing step which takes place before the processing step and which supplies the multi-filament product to the processing step, where between the processing step and the pre-processing step, a method (20) for detecting the structure of the textile multi-filament product according to the present invention is carried out and where the at least one parameter p describing the structure of the multi-filament product (1) and/or a change thereto Δp is used to regulate the pre-processing step and/or the processing step.

The method for detecting the structure of the multi-filament product can be integrated at least partially in the pre-processing step and/or in the actual processing step or post-processing step.

The pre-processing step can comprise or form a step of manufacturing the multi-filament product. That is, that the product can be examined directly after its manufacture or even during manufacture in order to then intervene if necessary in the production process in a corrective and creative manner.

It is also possible to carry out a process documentation on the basis of the detected data.

The pre-processing step can additionally or alternatively comprise or form a step of supplying the multi-filament product. Therefore, for example, an already-prefabricated product can be examined, for example, before a further processing.

The pre-processing step can be regulated, for example, by regulating—in particular feeding back—at least one pre-processing parameter, for example by means of a control parameter R, R′, which for example can be the result of the evaluation S4 and/or derivation S5.

In this case, for example, a thread tension, the type of impregnation, the amount of impregnation, the switching-on of spreading devices and/or the properties of spreading devices can be regulated.

The principle according to the invention can be widely used. The processing process can comprise or form, for example, at least one process of winding fiber spools, spreading, fiber winding, weaving and forming single- or multi-layer scrims.

If the presence of imperfections G′ is detected in the textile multi-filament product, at least one additional process in the pre-processing step and/or in the processing step can be begun or influenced depending on the extent of the presence of imperfections G′.

The at least one additional process can be a process from the group formed by a process of marking detected imperfections G′, a process of separating sections of the textile multi-filament product having detected imperfections G′ and a process of cutting away sections of the textile multi-filament product having detected imperfections G′, in particular in the case of narrow textiles, woven fabric bands and the like.

By means of the localisation of whatever type of imperfections, a further process step can therefore be triggered such as, for example, an automatic marking of the imperfection with a suitable marking, e.g. by ink, laser etc. This would allow defective material to be made re-usable, whereby imperfections G′ which are clearly identified can be avoided or separated out during a further processing. This is particularly relevant for woven fabrics and scrims.

These and further aspects of the present invention will be explained on the basis of the appended drawings.

### BRIEF DESCRIPTION OF THE FIGURES

FIG. 1 is a schematic view which shows one embodiment of a system according to the invention and method for processing a textile multi-filament product using an embodiment of the method according to the invention for detecting its structure.

FIG. 2 shows, in the form of a flow diagram, one embodiment of the method according to the invention for detecting the structure of a textile multi-filament product.

FIG. 3 is a schematic view showing another embodiment of the method according to the invention for detecting the structures of a textile multi-filament product and specifically taking particular account of the band width of a roving.

FIG. 4 shows another embodiment of the method according to the invention for detecting the structure of a textile multi-filament product and specifically using a video recording system in a process in which two rovings are processed.

FIG. 5 shows in schematic view another embodiment of the method according to the invention for processing a textile multi-filament product.

FIGS. 6A to 7C show in schematic form various possibilities for evaluating the primary detection data, here in connection with the derivation of the band width of a roving.

FIGS. 8A to 9C explain in schematic form how the structures, here in the sense of the band width B, can be determined independently of position in the line-wise evaluation of the primary detection data.

FIGS. 10A to 10C explain in schematic form how the structures, here in the sense of the band width B and the presence of a gap G′, can be determined independently of position, for example, in the case of a bandroving, scrim or woven fabric, in the line-wise evaluation of the primary detection data.

### DETAILED DESCRIPTION OF THE EMBODIMENTS

Embodiments of the present invention are described hereinafter. All the embodiments of the invention and their technical features and properties can be combined arbitrarily with one another in an individually isolated or random manner and combined without restriction.

Features or elements which are structurally and/or functionally the same, similar or which have the same effect are designed hereinafter in connection with the figures with the same reference numbers. A detailed description of these features or elements is not repeated in each case.

Reference is now made in detail to the drawings.

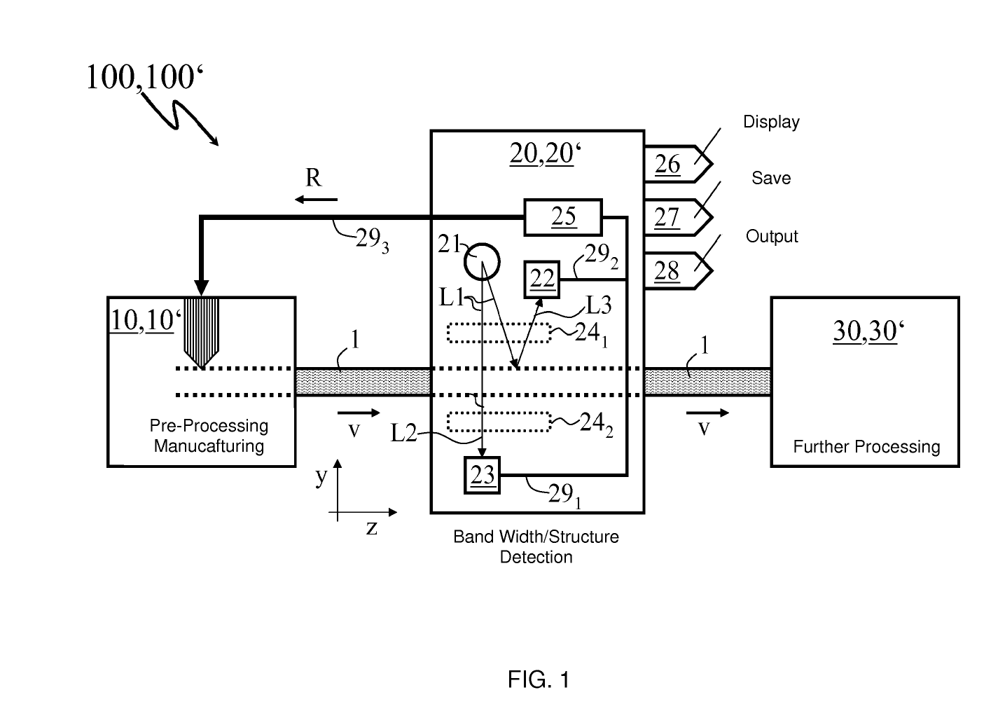

FIG. 1 shows schematically how one embodiment of the method according to the invention for detecting 20 the structure of a textile multi-filament product 1 can be integrated in a method 100 for processing a textile multi-filament product 1.

The processing step 100 from FIG. 1 consists of a pre-processing step 10 and an actual processing step 30. The pre-processing step 10 can, for example, include a method of manufacture for the textile multi-filament product 1. However it is also possible that the pre-processing step 10 is interpreted simply as a step of preparing or supplying a previously produced multi-filament product 1. The actual processing step 30 can include a further processing e.g. in the sense of producing a semi-finished product or similar. However, it is also feasible that the actual processing step 30 exclusively describes the take-up and intermediate storage of an intermediate product, e.g. of a roving or a fabric web on a spool or roller.

The method for detecting 20 the structure of the textile multi-filament product 1 is interposed between the pre-processing step 10 and the actual processing step 30. Physically, however, this method 20 can be integrated partially or completely in the pre-processing step 10 or in the actual processing step 30. The schematic diagram in FIG. 1 therefore represents in particular a conceptual splitting of the superordinate method for processing 100 the textile multi-filament product 1.

The pre-processing step 10 is particularly suitable for supplying the textile multi-filament product 1 to the method 20 for detecting the structure of the textile multi-filament product 1, e.g. at a speed v in the feed direction z.

The actual process for detecting 20 the structure is carried out by an appropriate processing device 20′. In FIG. 1, for this purpose the multi-filament product 1 is guided through an optical arrangement, which in this embodiment is formed by a light source 21 for emitting primary light L1, alternative or simultaneous optical recording or detecting devices 22 and 23 and optional and interposed optics 241 and 242.

It is also feasible to use other forms of electromagnetic radiation as primary radiation L1. For example, the infrared and/or the UV range can be used. In this case, the radiation source 21 and the recording or detecting devices 22, 23 must then be designed for the particular spectral range.

The description hereinafter will be made by reference to the optical, i.e. visual, spectral range but this is not a fundamental restriction.

The first optical recording device 22 is used to record light L3 reflected by the product 1. The second optical recording device 23 is used to record transmitted light L2. The first and second optical recording devices 22 and 23 can, for example, be formed by video cameras. Simpler systems are also feasible, e.g. in the sense of line scanning devices which, for example, exclusively deliver a brightness profile in a detecting direction y of the product 1 different from the feed direction z. The detecting direction (y) is particularly preferably disposed perpendicular to the feed direction (z).

The first and second optical recording devices 22 and 23 can be provided jointly or alternatively. The optics 241 and 242 can be suitable for increasing the resolution of the optical image and/or for regulating the contrast.

The first and second optical recording devices 22 and 23 are connected via lines 291 and 292 to a provided regulating device 25. The regulating device 25 is used to record the optically produced signals supplied by the optical recording devices as primary detection data. The primary detection data or data derived therefrom, e.g. in the sense of a parameter p describing the structure of the multi-filament product 1 or a change thereto Δp, can be displayed 26, stored 27 or simply output 28 by means of suitable process steps or devices.

FIG. 1 shows that by way of the evaluation of the primary detection data by means of the regulating device 25 via the line 293, a control parameter R is delivered to the pre-processing step 10 and the corresponding pre-processing device 10′ in order to regulate the pre-processing. This pre-processing 10 can be, for example, adapted with regard to the production parameters to produce the textile multi-filament product 1. This can, for example, comprise the type and extent of an impregnation with which the initial materials are treated. However, it can also comprise mechanical parameters, for example the formation or a mechanical pre-tensioning of the supplied threads or the execution or the properties of spreading processes.

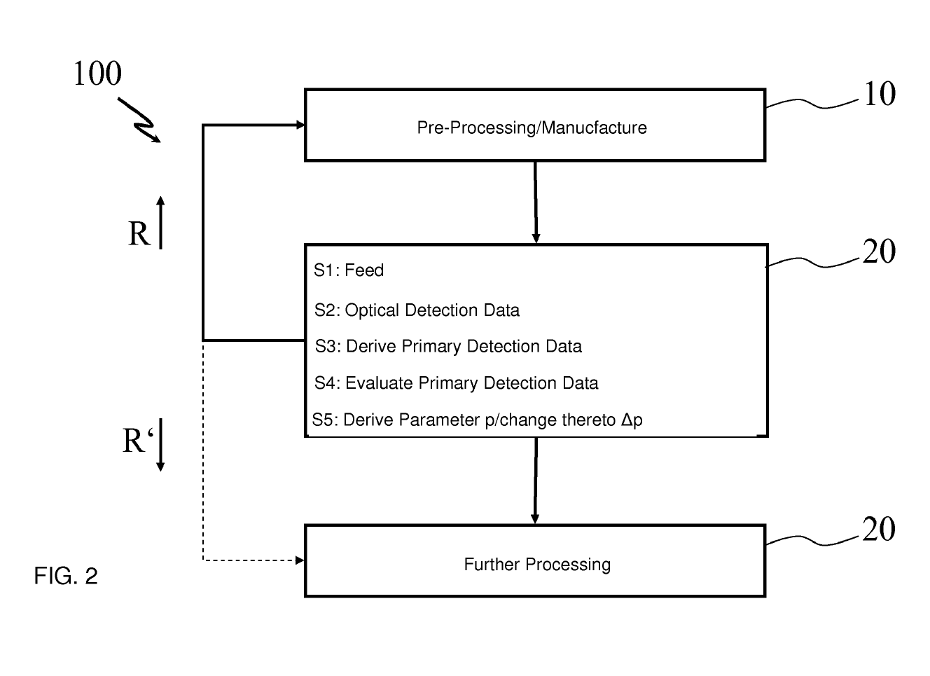

FIG. 2 is a schematic block diagram showing a method for processing 100 a textile multi-filament product 1 using the method according to the invention for detecting 20 the structure of a textile multi-filament product 1.

It should be noted that the arrangement shown in FIG. 2 fundamentally only shows a conceptual division of the pre-processing step 10, the method for detecting 20 the structure of the textile multi-filament product 1 and the actual processing step 30 of the method 100.

In practice, the processes at steps 10, 20 and 30 generally take place simultaneously. They can, however, be configured to be at least partially integrated into one another, in particular in regard to the devices 10′, 20′, 30′ which implement them.

The method for detecting 20 the structure of the textile multi-filament product 1 comprises a step S1 of feeding the multi-filament product 1 in a feed direction z, a step of linear/sectional optical detection S2 of the textile multi-filament product 1 in a detecting direction y different from the feed direction, a step of obtaining S3 primary detection data by the optical detection, a step of evaluating S4 the primary detection data and by this means a step of deriving S5 a parameter p describing the structure of the textile multi-filament product 1 and/or a change thereto Δp from the evaluation of the primary detection data.

From the analysis of the parameter p describing the structure of the textile multi-filament product 1 and/or a change thereto Δp, an influencing of the pre-processing step 10, the actual processing step 30 or both can be derived.

In FIG. 2 the influencing of the pre-processing step 10 is indicated by means of a control parameter R. Optionally via a—possibly different—control parameter R′ it is possible to influence the actual processing step 30, e.g. in order to adequately react to the properties of the textile multi-filament product 1—described by the parameter p and the change thereto Δp—in the further processing of step 30.

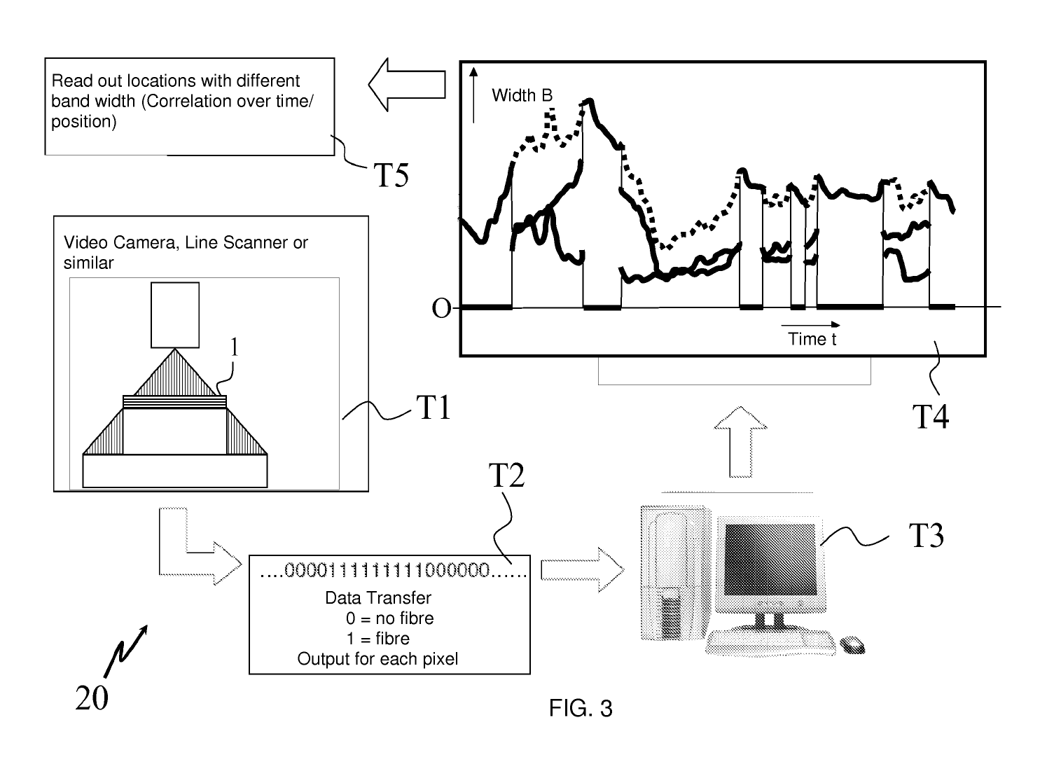

FIG. 3 shows in the form of a block diagram one possible application of the invention in corresponding production or control processes. This especially comprises here the online measurement or real-time measurement during the winding and/or spreading of textile multi-filament products 1, e.g. rovings.

In section T1 a product 1 which has been supplied and passed through is detected optically, and specifically linearly or sectionally, by means of a video camera.

In step T2 bit sequences are extracted from this primary detection data from the optical detection in the sense of a one-bit coding, which bit sequences represent the presence or the absence of fibers along the detection line along the detecting direction y during optical detection, i.e. in cross-section.

On the basis of the optical arrangement and the evaluation from FIG. 2, this results in a number 0 being assigned here to the absence of a fiber and a number 1 being assigned to the presence of the fiber along the detecting direction different from the feed direction z. The description is made for each pixel, i.e. for each image element of the evaluated detected lines or image lines.

A cohesive sequence of “1” thus gives an area covered by fibers, ideally therefore specifically the band width of the supplied textile multi-filament product 1 at this point.

In section T3 the bit sequences are then correlated with the speed v of supplying the product 1, its position and the time in order to then obtain—here in a graphical representation of the band width B as a function of time—a characterisation of the properties of the basic multi-filament product 1 as shown in section T4 of FIG. 1.

From the graph of the section T4 from FIG. 3, in a further step T5 by means of the correlation over time and position, the structural information, here in the form of information about the different band width B can be specified and possibly read out.

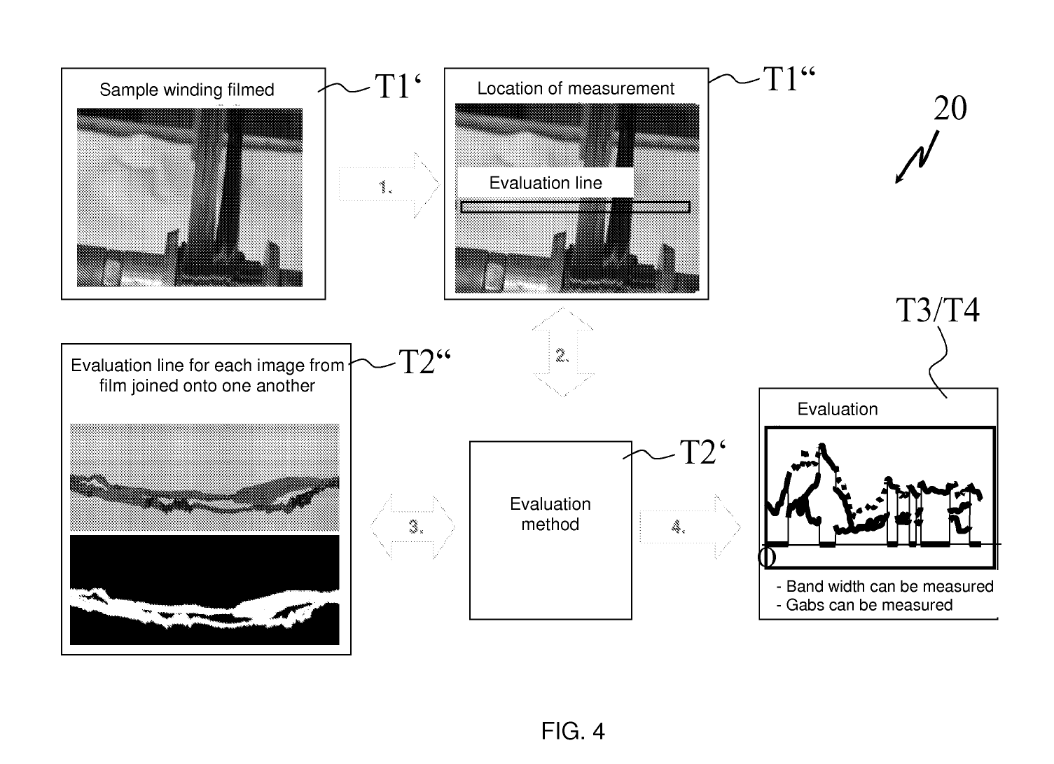

FIG. 4 shows other details from the processes shown in FIG. 3.

In sections T1′ and T1″ to section T1 from FIG. 3, a film recording of a winding with a sample with two different rovings is described here. In section T1″ the corresponding evaluation line is marked in which the linear/sectional analysis of the two rovings is made in the detected primary data in the sense of the video recording.

In sections T2′ and T2″ an evaluation of the successive line information is then made by means of appropriate modelling whilst correlating with the time and the position during supply of the textile multi-filament product 1.

By means of the corresponding correlations in section T2′, a relationship can then be made between the arrangements of the line information shown in section T2″ and the time sequence of the band widths of the individual fibers and the total band width as shown in section T3/T4 of FIG. 4.

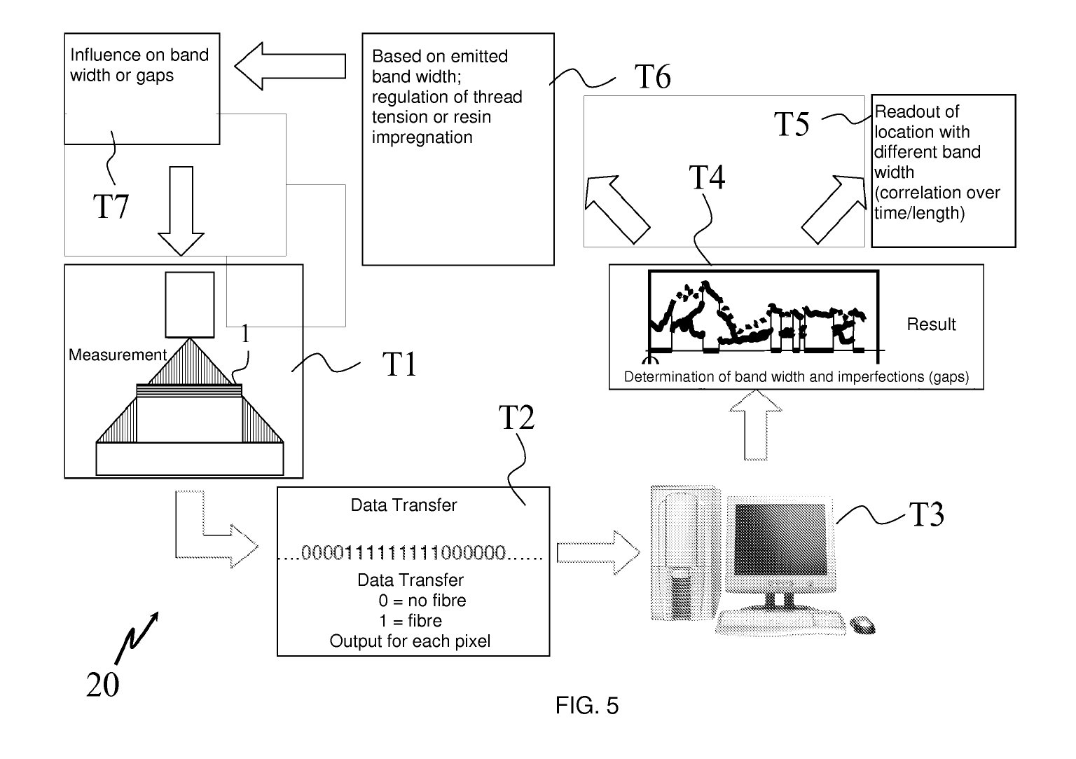

FIG. 5 shows in the form of a block diagram how a sequence similar to the embodiment of FIG. 3 can be used for a method for detecting the structure of a textile multi-filament product 1 in a method for processing/manufacturing the textile multi-filament product 1.

Here the process sequence from FIG. 3 is expended by steps T6 and T7 which, on the basis of the determined structure parameter p and/or a change thereto Δp, e.g. based on the determined band width B, derive a regulation of processing or manufacturing parameters and thereby influence the corresponding structural quantities of the supplied or manufactured textile multi-filament product 1, e.g. the band width or gaps in the woven fabric.

All the operating parameters relevant for the processing or pre-processing and in particular for the production can be regulated, for example, the thread tension, the presence and the type and manner of spreading, the presence and the type and manner of a possible impregnation of the starting materials etc.

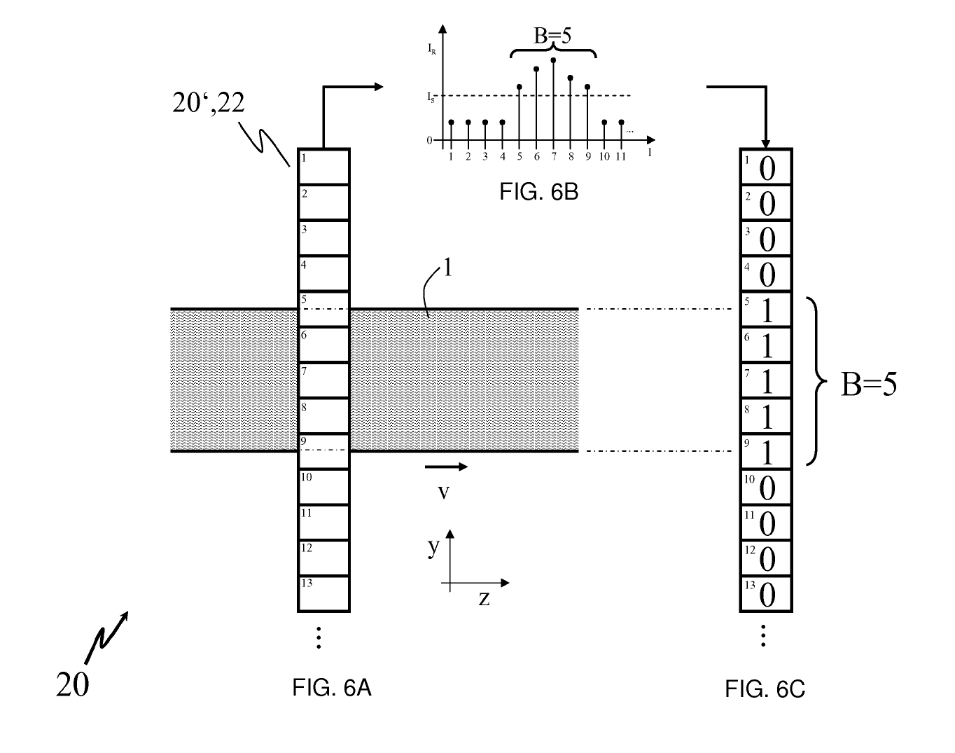

FIGS. 6A to 6C describe a possible procedure for deriving the band width B of a multi-filament product 1 within an embodiment of the method 20 for detecting 20 the structure.

The arrangement of the optical recording device 22 is shown schematically from the device 20′ for detecting the structure of the textile multi-filament product 1. This optical recording device 22 operates, as was shown in connection with FIG. 1, on the basis of the light L3 reflected by the product 1.

The optical detecting device 22 consists of a plurality of individual light detecting elements I1, I2, . . . From the arrangement in FIG. 1 it follows that the optical recording device 22 measures the light L3 reflected by the product 1. Assuming that the product 1 comprises a “light” structure against a comparatively dark background, the intensity distribution shown schematically in the graph in FIG. 6B is obtained in reflection.

Assuming a specific threshold value IS for the distribution of the intensity IR in reflection, the one-bit coding shown in FIG. 5C can be derived, where all those light detection elements or image elements I1, I2, . . . , whose intensity I lies above the threshold value IS are assigned a “1” whereas the other light detection elements or image elements are assigned a “0”.

A band width B=5 in units of the image elements or light detection elements I, I1, I2, . . . of the basic optical recording device 22 is obtained from such an assignment.

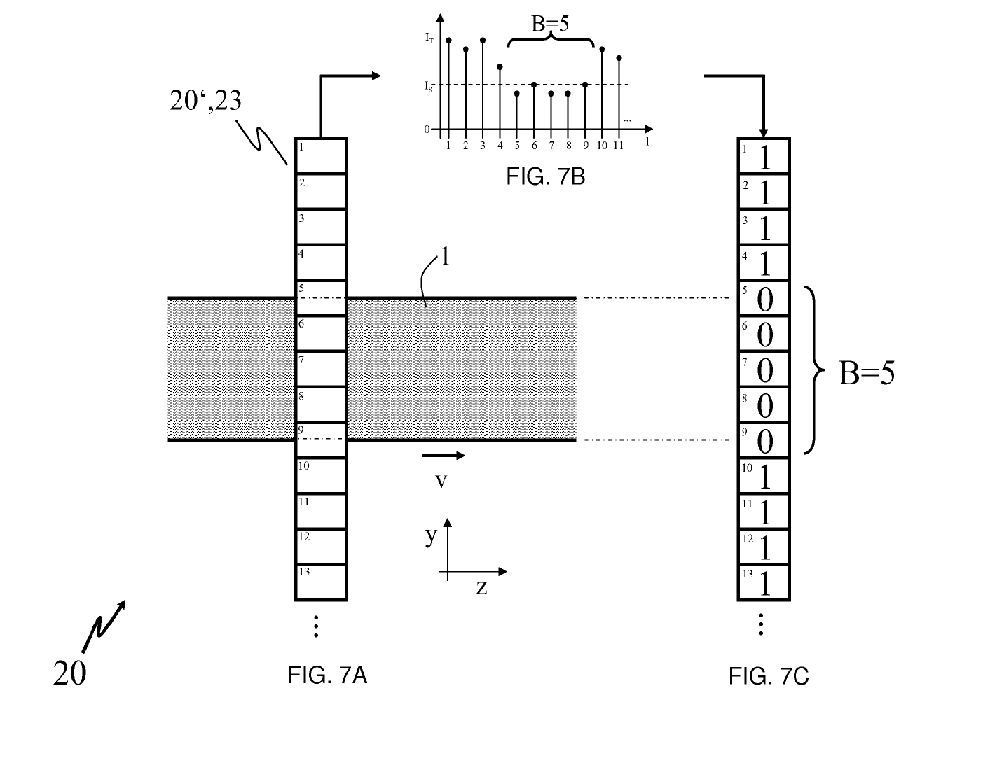

FIGS. 7A to 7C show a diagram similar to FIG. 6A to 6C where here however the second optical recording device 23 with light recording elements I1, I2, . . . is taken as the basis which operates in transmission in relation to the light source 21 from the arrangement 20′ of FIG. 1.

In FIG. 7B it is therefore clear that the light detection elements or image elements I5, . . . I9 are covered and shaded so that these receive an intensity IT in transmission which does not exceed the threshold value Is so that a bit sequence shown in FIG. 7C having a derived band width B=5 is obtained for the product 1 under the same one-bit coding as in the sequence of FIG. 6A to 6C.

In principle, other codings are also possible, for example, codings having more than one bit where different threshold values should then be taken as the basis for the intensity distribution.

The arrangements for the light receiving elements I1, I2, . . . shown in FIGS. 6A and 7A can also, for the sake of simplicity, comprise corresponding pixels, in particular of a video line, of a video image if a video system is used instead of a line scanner.

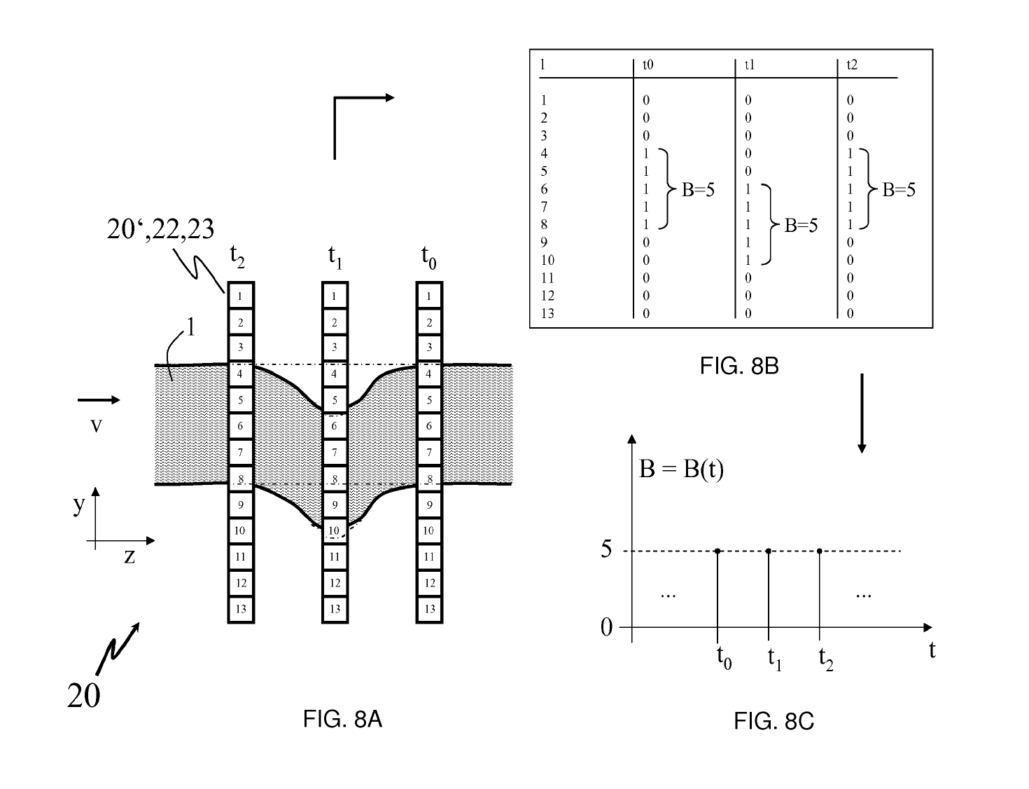

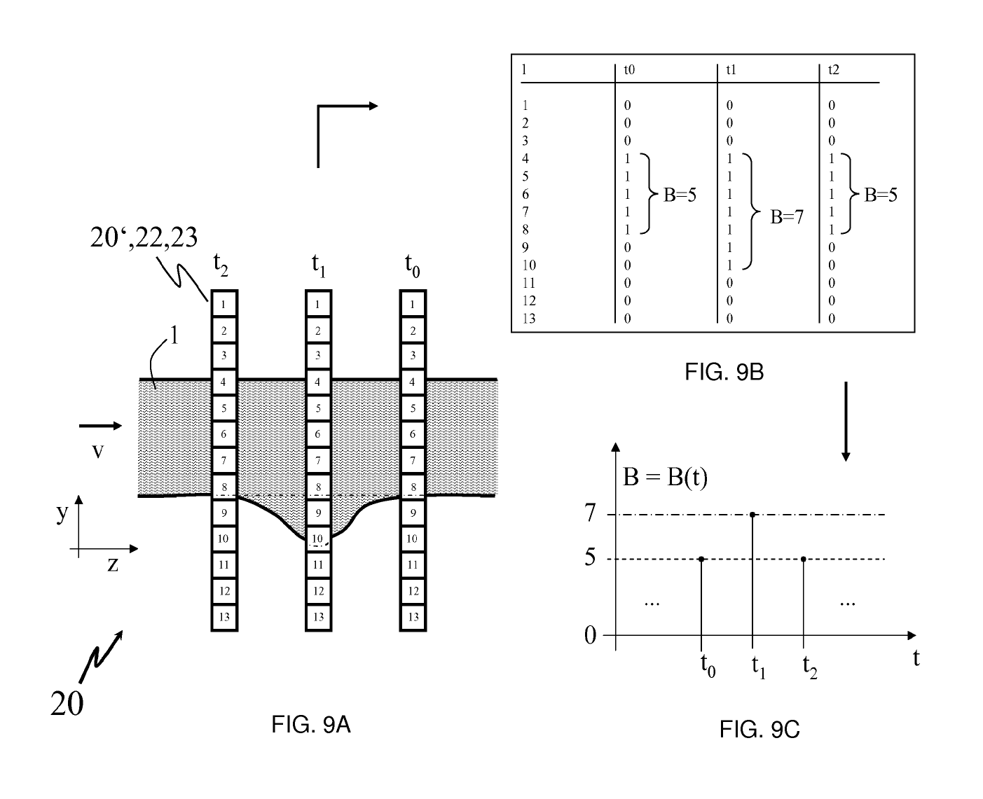

FIGS. 8A to 8C and 9A to 9C describe situations such as can be obtained in practice with the arrangements shown in FIGS. 6A to 7C.

FIG. 8A shows the course of a textile multi-filament product 1. As a result of the feed speed v in the feeding direction z, the situations designated with the time points t0, t1, t2 are obtained for the optical recording devices 22 and 23 in the course of time. This means that at the different time points t0, t1, t2 different light recording elements 11, 12, are exposed/shaded and specifically depending on the course, structure and position of the product 1 above or below the respective optical recording device 22 or 23.

The table of values in FIG. 8B can be derived from the arrangements shown in FIG. 8A. In FIG. 8A the product 1 is formed with substantially constant band width but with a curvature in the temporal/spatial profile. As a result, the respective band width B=B(t) with the value 5 does not change for the different time points t0, t1, t2 but the position of the cohesive bit sequence characterising the band width with nothing but ones.

FIG. 8C shows the time behavior of the band width B=B(t) as a function of the time t once again. A constant band width B=5 is obtained regardless of the position of the product 1 in relation to the optical recording devices 22, 23.

The situation is different if the structure shown in FIG. 9A is taken as the basis.

At times t0 and t2 the situation is identical to the arrangement in FIG. 8A. At time t1 however, the product 1 is not curved but has a thickening, i.e. an increased band width B.

The table shown in FIG. 9B can again be derived from FIG. 9A where here for the time t1 the length of the bit sequence with nothing but ones is 7 so that for the time t1 a larger band width with B=7 is obtained. The result of the evaluation from the table in FIG. 9B is shown again graphically in the graph in FIG. 9C.

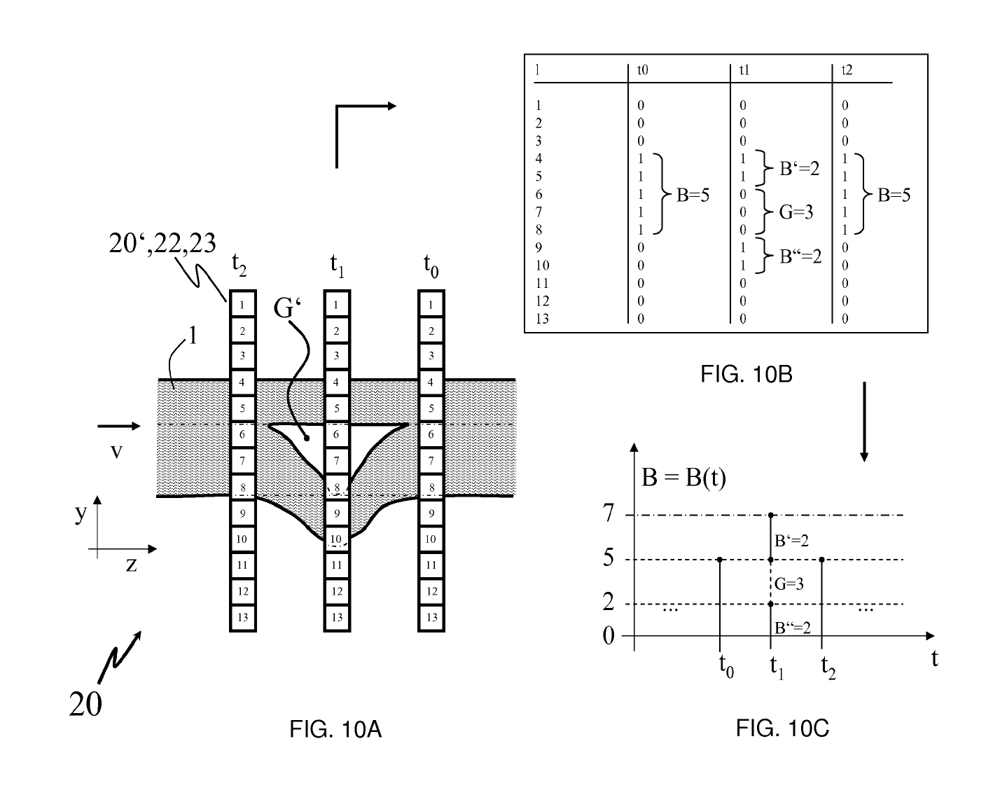

FIGS. 10A to 10C show similarly to FIGS. 8A to 8C and 9A to 9C a possibility for evaluation when there is a gap or a space G′ having a certain local gap width G, e.g. specifically when a woven fabric, scrim or a bandroving are to be detected as textile multi-filament product 1.

According to FIG. 10A such a textile multi-filament product 1 supplied at the speed v in the z direction actually has a band width B, specifically among other things at the measurement times t0 and t2. At one or more locations however, one or more gaps G′ are present in the structure of the textile multi-filament product 1 which have a specific local gap width G in the detecting direction y. A single gap at the measurement time t1 is shown in FIG. 10A.

The detection and evaluation table in FIG. 10B shows the result, namely a continuous structure in the y direction having the band width B=5 at measurement times t0 and t2 and a gap structure at measurement time t1 comprising a gap G′ having the local gap width G=3 and substructures having local sub-band widths B′=2 and B″=2.

FIG. 10C shows this result graphically in the time behavior.

These and other aspects are now explained further on the basis of the following observations:

In particular when considering winding processes in which, for example a carbon roving 50K corresponding to a number of filaments of 50,000 is processed, it is found that fluctuations in the band width of the product occur during the winding. Fluctuations in the basic starting material can frequently be perceived as causes particularly when carbon fibers having a high number of fibers are used, typically in the range of 50K or more.

According to the invention therefore a system and a method are proposed for monitoring the band width which allow the band width or other structural elements to be measured, evaluated, and output by means of suitable measuring means and to then derive control parameters therefrom if appropriate.

The depositing of a product, e.g. a roving, is monitored, for example, by means of a video system. To this end, the band width of the roving can be measured online or in real time. If several rovings are processed simultaneously, in addition to the band width the presence of the distribution of gaps in spread fibers can also be recorded and characterised. Time and location of the gaps can thereby be detected and documented.

Possible applications are the winding of fiber spools (C fiber production), the winding, spreading for single- or multi-ply scrims, quality control for single- or multiply scrims (in particular with regard to gaps), TFP (tailored fiber placement) processes/products, fiber or band deposition, weaving and scrim production. Applications are possible and appropriate if fibers of 1K to 50K or even over 50K are involved. Application is also feasible in structures of up to 320K.

### REFERENCE LIST

1 Textile multi-filament product, roving yarn, yarn, twist, roving, single- or multiply scrim, woven fabric
10 Pre-processing section/step
10′ Device for pre-processing
20 Method according to the invention for detecting the structure of a textile multi-filament product
20′ Device for executing the method according to the invention
21 Light source, radiation source
22 First optical recording device, first light detecting device, first detecting/recording device for electromagnetic radiation
23 Second optical recording device, second light detecting device, second detecting/recording device for electromagnetic radiation
241 Optical imaging device, imaging device for electromagnetic radiation
242 Optical imaging device, imaging device for electromagnetic radiation
25 Evaluation device, regulating device
26 Display, display device
27 Store, storage device
28 Output, output device
291 Line
292 Line
293 Regulating line, line
30 Actual processing step, main processing step
30′ Device for the actual processing/main processing
100 Method for processing a multi-filament product
100′ Apparatus/system for processing a multi-filament product
B Band width
G Local gap width
G′ Space, gap, imperfection
I Light detecting element, detecting element for electromagnetic radiation
I1, I2, . . . Light detecting element, detecting element for electromagnetic radiation
L1 Primary light, primary radiation
L2 Transmitted light, transmitted electromagnetic radiation
L3 Reflected light, reflected electromagnetic radiation
p Parameter describing the structure
Δp Change of parameter p
R Control parameter
R′ Control parameter
t Time
t0 Time point
t1 Time point
t2 Time point
v Feeding speed
y Detecting direction
z Feed direction

1-18. (canceled)

19. A method for processing a multi-filament product, the method which comprises:
a pre-processing step for supplying a multi-filament product;
subsequently to the pre-processing step, carrying out a processing step for processing the multi-filament product supplied in the pre-processing step; and
a detection process, to be carried out between the processing step and the pre-processing step, for detecting a structure of the textile multi-filament product, the detecting process including the following steps S1 to S5:
(S1) feeding a multi-filament product in a feed direction;
(S2) carrying out linear/sectional optical detection of the multi-filament product in a detecting direction different from the feed direction and thereby:
(S3) obtaining primary detection data;
(S4) evaluating the primary detection data; and
(S5) deriving at least one parameter describing a structure of the multi-filament product and/or a change thereto from the step of evaluating (S4) the primary detection data; and
utilizing the parameter describing the structure of the multi-filament product and/or the change thereto in a closed-loop control of one or both of the pre-processing step or the processing step.

20. The method according to claim 19, wherein the detection process for detecting the structure of the multi-filament product is integrated at least partially in one or both of the pre-processing step or the processing step.

21. The method according to claim 19, wherein the pre-processing step comprises manufacturing the multi-filament product.

22. The method according to claim 19, wherein the closed-loop control of the pre-processing step comprises controlling at least one pre-processing parameter.

23. The method according to claim 22, wherein the closed-loop control of the pre-processing step comprises feeding back at least one pre-processing parameter.

24. The method according to claim 19, wherein the closed-loop control comprises controlling one or more parameters selected from the group consisting of a thread tension, a type of impregnation, an amount of impregnation, a switching-on of spreading devices, and properties of the spreading devices.

25. The method according to claim 19, which comprises at least one process selected from the group consisting of winding fiber spools, spreading, fiber winding, weaving, forming single-scrims, forming multi-layer scrims, and fiber splicing.

26. The method according to claim 19, which comprises:
monitoring the textile multi-filament product for a presence of imperfections; and
if imperfections are detected, performing at least one additional process in the pre-processing step and/or in the processing step depending on an extent of the presence of imperfections.

27. The method according to claim 26, wherein the performing step comprises beginning or influencing the at least one additional process.

28. The method according to claim 26, wherein the at least one additional process is a process selected from the group consisting of marking detected imperfections, separating out sections of the textile multi-filament product having detected imperfections, and cutting away sections of the textile multi-filament product having detected imperfections.
